(19) United States
(12) Patent Application Publication
(10) Pub. No.: US 2009/0241392 A1
(43) Pub. Date: Oct. 1, 2009

(54) Electromagnetic Blocking Tag Holder

(75) Inventors: Marvin Timothy Long, Matthews, NC (US); Karl Allen Ziegler, Greenwood, SC (US)

Correspondence Address: DORITY & MANNING, P.A., POST OFFICE BOX 1449, GREENVILLE, SC, 29602-1449, US

(73) Assignee: LAMINEX, INC., Fort Mill, SC (US)

(21) Appl. No.: 12/411,843

(22) Filed: Mar. 26, 2009

Related U.S. Application Data
(60) Provisional application No. 61/039,662, filed on Mar. 26, 2008.

(51) Int. Cl. G09F 3/18

(52) U.S. Cl. 40/661

(57) ABSTRACT

Electromagnetic blocking tag holders and methods of their use are generally provided. The holder can include an identification tag holding area configured to removably secure an identification tag inserted within the holding area while allowing a face of the inserted identification tag to remain visible. An electromagnetic blocker is attached to the holding area, and is configured to electromagnetically inhibit and prevent skimming or stealing of electronic information stored in the inserted identification tag.

### PRIORITY INFORMATION

The present application claims priority to U.S. Provisional Patent Application Ser. No. 61/039,662 filed on Mar. 26, 2008 titled “Electromagnetic Blocking Device”, the disclosure of which is incorporated by reference herein.

### BACKGROUND OF THE INVENTION

Identification tags have become a common method of providing the identity of the wearer by including the name and picture of the card's owner and other important identification information. For example, many locales, such as businesses, manufacturers, schools, hospitals, government offices, etc., require that employees display their identification tag at all times to allow immediate visual identification of the employee.

Some of these identification tags can carry electronic information. This electronic information is typically stored on the cards in the form of passive radio-frequency identification (RFID) circuits, active RFID circuits, and electronic article surveillance (EAS) circuits.

Typically, a RFID tag is an object applied to or incorporated into a card for the purpose of identification using radio waves. Most RFID tags contain at least two parts: (1) an integrated circuit for storing and processing information, modulating and demodulating a radio-frequency (RF) signal and (2) an antenna for receiving and transmitting the signal. RFID tags can corn in three general varieties: passive, active, or semi-passive (also known as battery-assisted). Passive tags require no internal power search, and are only activated when a reader is nearby to provide power. Semi-passive and active tags, on the other hand, require a power source (e.g., a battery).

EAS tags are typically made of a strip of amorphous metal having a low magnetic saturation value. This strip is also lined with a strip of ferromagnetic material with a coercive field (magnetic “hardness”). Detection is achieved using sensing harmonics and sum or difference signals generated by the non-linear magnetic response of the material under a mixture of low-frequency (e.g. about 10 Hz to about 1000 Hz) magnetic fields. When the ferromagnetic material is magnetized, it biases the amorphous metal strip into saturation where it no longer produces harmonics. These tags are activated by demagnetization and deactivated with magnetization. EAS tags are commonly used to prevent shoplifting from retail stores by sending an alarm when the tag is sensed. However, EAS tags can also be used as an identifier by confirming the presence of the proper individual gaining access to a location. Such a use is akin to using an electronic pass-key.

Regrettably, third parties and/or outsiders can use electronic devices to “skim” or otherwise steal the identification information stored electronically in such tags. For example, a third party outsider in close proximity to the card can skim or steal the electronic information stored on the card by activating the card, if necessary, and by reading the information stored in the circuitry of the card. This electronic information can then be duplicated and used for nefarious activities. Unfortunately, this practice has been growing as the sophistication of thieves grows.

Card protectors that attempt to inhibit the reading of electronic information stored on such tags completely encase the tag, preventing immediate visual reading of the information shown on the face of the ID tag.

As such, a need currently exists for an ID tag holder that can protect the electronic information stored in the card while allowing the face of the ID tag to remain visible to others.

### SUMMARY OF THE INVENTION

Objects and advantages of the invention will be set forth in part in the following description, or may be obvious from the description, or may be learned through practice of the invention.

In general, the present disclosure is directed to an electromagnetic blocking tag holder and methods of using the holder. The holder includes an ID tag holding area attached to an electromagnetic blocker. The identification tag holding area is configured to removably secure an identification tag inserted while allowing a face of the inserted identification tag to remain visible. The electromagnetic blocker (e.g., a electromagnetic blocking paper) is configured to electromagnetically inhibit and prevent skimming or stealing of electronic information stored in the inserted identification tag.

The ID tag holding area can be, in one embodiment, defined by opposing side edges, a top edge, and a bottom edge. Each of the opposing side edges, the top edge, and the bottom edge extends substantially perpendicular from an inner surface. The inner surface defines an indentation along the bottom edge. Overhang members extend substantially perpendicular from each opposing side edges and over the inner surface. In another embodiment, the ID tag holding area can be defined by opposing side edges and a top edge without any bottom edge. A transparent window layer can be attached to the holder along the side edges and the top edge to cover substantially all of the holding area. As such, a bottom opening for receiving an identification tag is defined between the transparent window layer, the inner surface, and the opposing side edges. A grip bar can be included in the inner surface and configured to provide a holding force to an inserted identification tag by pressing the inserted ID tag against the transparent window layer.

The electromagnetic blocking tag holder can further include a second identification tag holding area for receiving and holding a second ID tag. The second holding area can be defined by opposing second side edges, a second top edge, and a second bottom edge. Each of the opposing second side edges, the second top edge, and the second bottom edge extends substantially perpendicular from an opposite side of the inner surface. The opposite side of the inner surface defines an indentation along the second bottom edge. Second overhang members extend substantially perpendicular from each opposing second side edges and over the opposite side of the inner surface to secure a second identification tag inserted within the second holding area while allowing a face of the inserted second identification tag to remain visible.

A method of protecting electronic information stored in an identification tag that defines a face is also generally provided. The identification tag can be inserted into the holding area to removably secure the identification tag within the holding area while allowing a face of the inserted identification tag to remain visible. The electromagnetic blocker attached to the holding area can electromagnetically inhibit and prevent skimming or stealing of electronic information stored in the inserted identification tag.

Other features and aspects of the present invention are discussed in greater detail below.

### BRIEF DESCRIPTION OF THE DRAWINGS

A full and enabling disclosure of the present invention, including the best mode thereof to one skilled in the art, is set forth more particularly in the remainder of the specification, which includes reference to the accompanying figures, in which:

FIG. 1 shows a perspective view of an exemplary identification tag holder according to one embodiment of the present invention;

FIG. 1A shows a perspective view of a method of inserting an identification tag into the holding area of the holder shown in FIG. 1;

FIG. 2 shows a top view of the exemplary identification tag holder shown in FIG. 1;

FIG. 3 shows a cross-sectional view along the longitudinal axis of the identification tag holder shown in FIG. 1;

FIG. 4 shows a cross-sectional view along the lateral axis of the identification tag holder shown in FIG. 1;

FIG. 5 shows a perspective view of an exemplary identification tag holder according to another embodiment of the present invention;

FIG. 6 shows a front view of the identification tag holder shown in FIG. 5;

FIG. 7 shows a cross-sectional view along the longitudinal axis of the identification tag holder shown in FIG. 5;

FIG. 7A shows the cross-sectional view of FIG. 7 with an ID tag inserted into the holding area of the holder;

FIG. 8 shows a perspective view of an exemplary identification tag holder according to yet another embodiment of the present invention;

FIG. 9 shows a front view of the identification tag holder of FIG. 9; and

FIG. 10 shows a back view of the identification tag holder of FIG. 8.

Repeat use of reference characters in the present specification and drawings is intended to represent the same or analogous features or elements of the present invention.

### DETAILED DESCRIPTION OF PARTICULAR EMBODIMENTS

Reference now will be made to the embodiments of the invention, one or more examples of which are set forth below. Each example is provided by way of an explanation of the invention, not as a limitation of the invention. In fact, it will be apparent to those skilled in the art that various modifications and variations can be made in the invention without departing from the scope or spirit of the invention. For instance, features illustrated or described as one embodiment can be used on another embodiment to yield still a further embodiment. Thus, It is intended that the present invention cover such modifications and variations as come within the scope of the appended claims and their equivalents. It is to be understood by one of ordinary skill in the art that the present discussion is a description of exemplary embodiments only, and is not intended as limiting the broader aspects of the present invention, which broader aspects are embodied exemplary constructions.

In general, the present invention is directed to an identification tag holder configured to electromagnetically block skimming or stealing of electronic information stored in the tag while allowing the face of the identification tag to be readily viewed. Thus, an identification tag can be safely carried, displaying the face of the identification tag, while protecting any electronically stored information in the tag.

As used herein, the term “identification tag” or “ID tag” refers to cards, building passes, credit cards, passports, and other account or personal identification cards that have a readable face and contain electronic information. Examples of identification tags include RFID tags (passive, semi-passive, and active) and EAS tags. Although the present discussion focuses on passive RFID tags, it is recognized that a similar system can be used for active and semi-active RFID tags. The face of the identification tag can show information such as the name of the tag owner, a picture of the tag owner, the position of the owner (e.g., an employee's title), and other identification information.

### A. Holder

The identification tag holder is configured to receive and removably secure an inserted identification tag and allow viewing of a surface of the inserted identification tag (i.e., a face of the identification tag). Additionally, the holder is configured such that any inserted identification tag can be readily removed from the holding frame when desired.

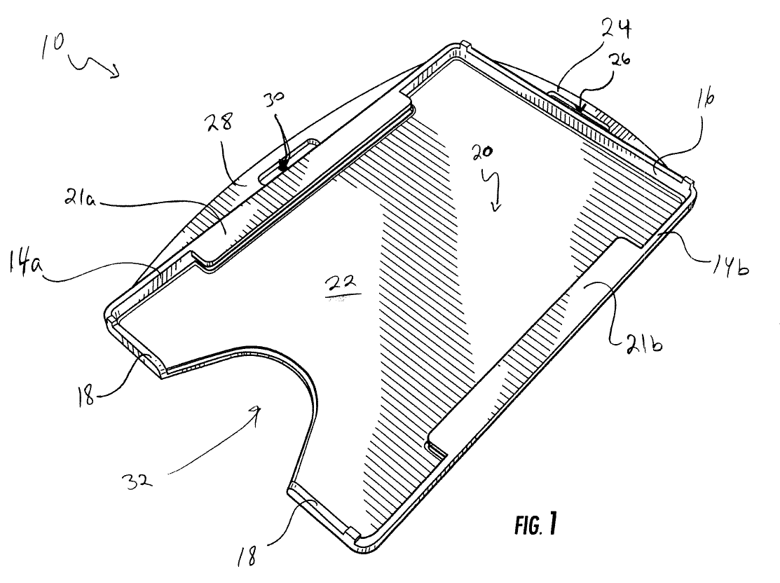

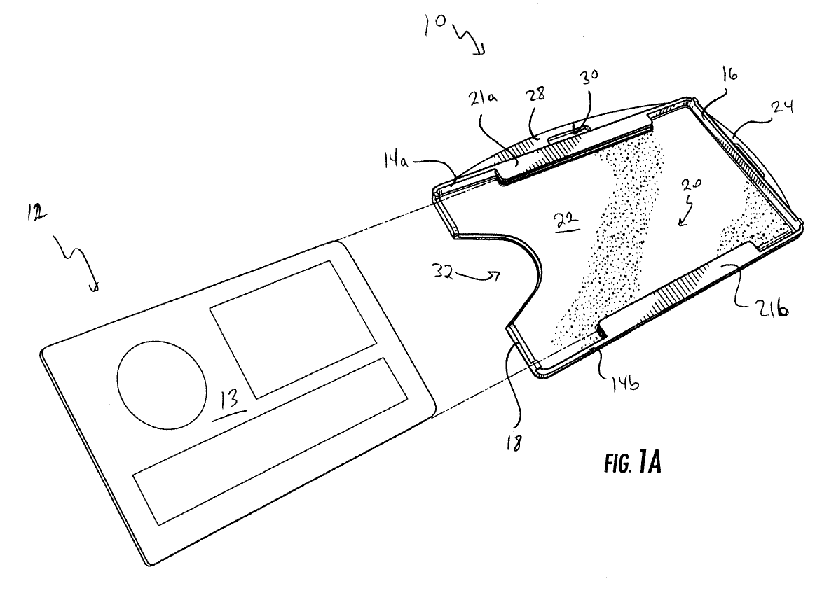

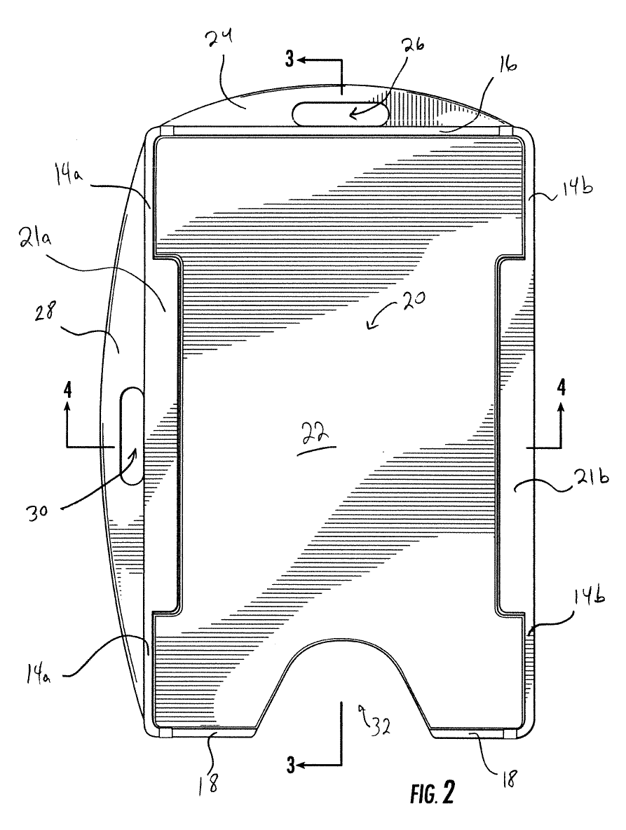

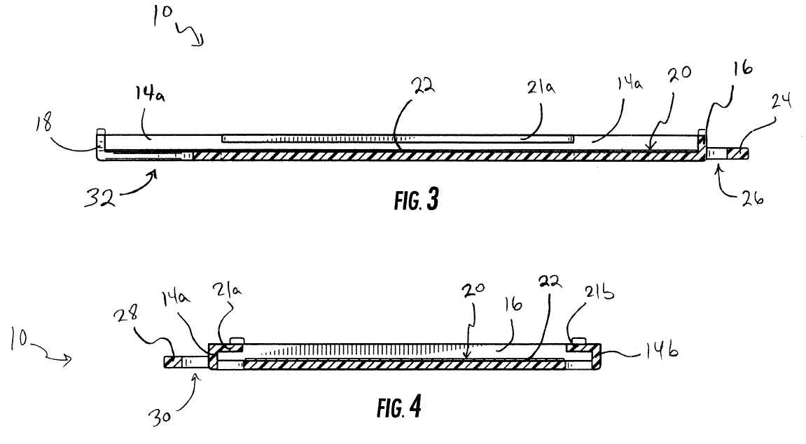

Referring to the exemplary embodiment shown in FIGS. 1-4, the holder 10 has a ID card holding area defined by opposed side edges 14a,14b, top edge 16, and bottom edge 18. Each of the opposed side edges 14a,14b, the top edge 16, and the bottom edge 18 extends substantially perpendicular from the inner surface 20. These edges generally form the shape of the ID tag to be inserted, and can be shaped or sized to fit any desired ID tag. As shown, these edges collectively form a holding area in the shape of a typical rectangular ID tag. The holding area can be generally sized only slightly larger than the size of the ID tag to be inserted (e.g., from about 101% to about 110% of the size of the ID tag to be inserted), allowing the holding area to secure an ID tag.

Overhanging members 21a,21b extend perpendicularly from each side edges 14a,14b, respectively, to secure an inserted ID tag within the holding area of holder 10. FIG. 1A shows an identification tag 12 being inserted into the holding area of the holder 10 by positioning the ID tag over the bottom edge 18 and then sliding the ID tag 12 between the inner surface 20 and the overhang members 21a,21b. Once fully inserted into the holding area of the holder 10, the ID tag 12 will remain secured in place through (a) the boundaries defined by side edges 14a,14b, the top edge 16, the bottom edge 18, (b) the inner surface 20, and (c) the overhang members 21a,21b. While inserted into the holder 10, the face 13 of the ID tag 12 remains readily visible since no layer covers the face 13 of the ID tag 12 (except where overhang members 21a,21b slightly overlap the ID tag 12).

However, the ID tag 12 can be easily removed from the holder 10 due to the tab formed by indentation 32 defined by the inner surface 20 along the bottom edge 18. When a user desires to remove the inserted ID tag 12 from the holder 10, he or she simply applies slight pressure to the ID tag 12 through the indentation 32 to slide the ID tag 12 over the bottom edge 18 and out of the bottom of the holder 10.

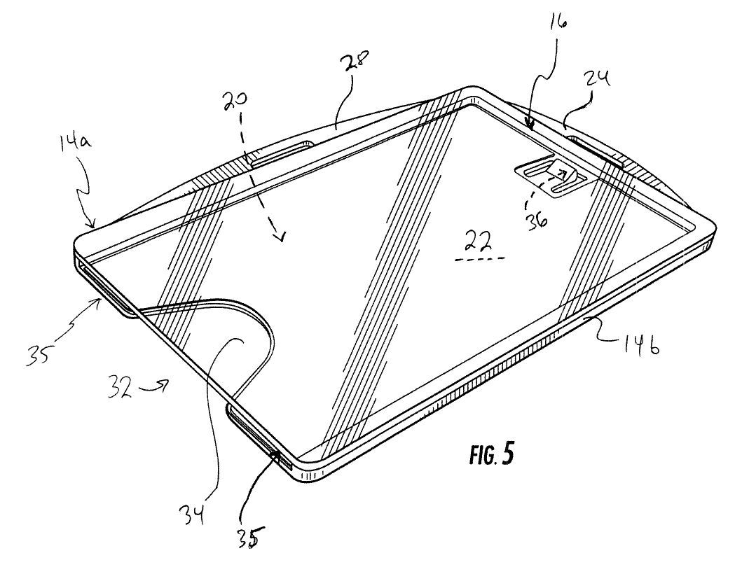

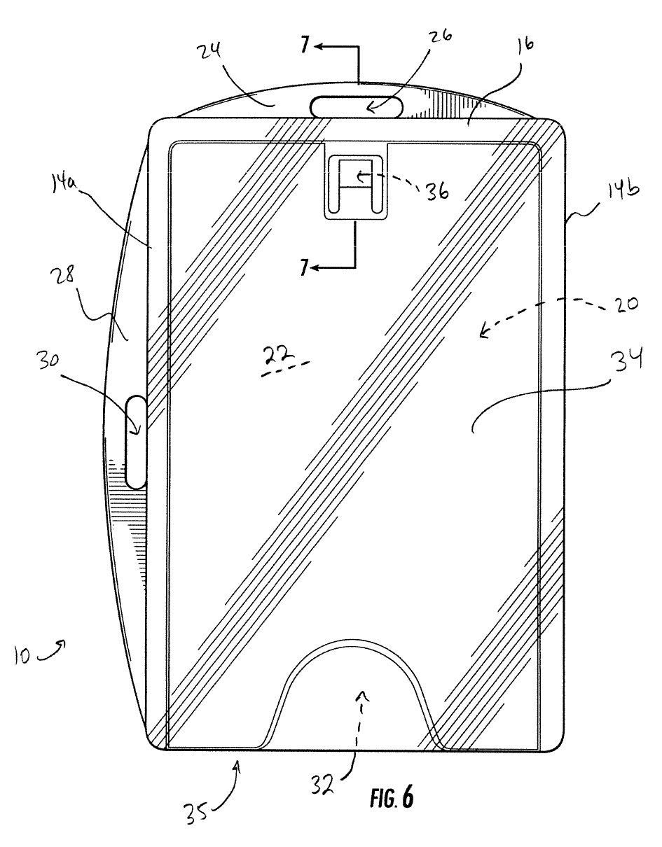

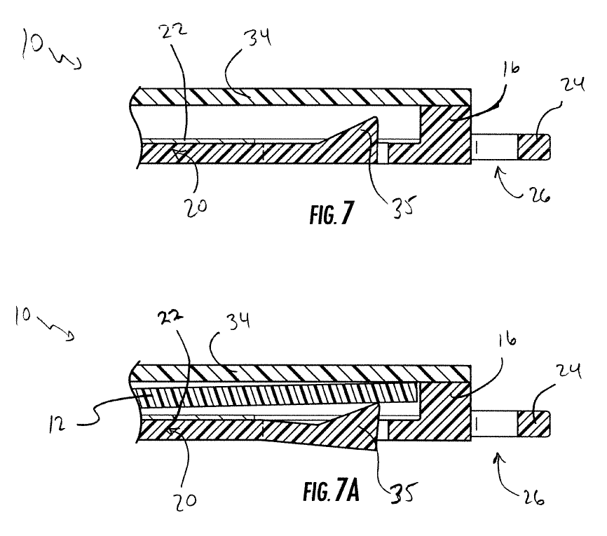

FIG. 5 shows an alternative embodiment of an ID tag holder 10 having a transparent window layer 34 overlying the entire face of any inserted ID tag 12. In this embodiment, the opposing side edges 14a,14b and top edge 16 define the holding area for an inserted ID tag 12. The transparent window layer 34 is attached to the holder along the side edges 14a,14b and the top edge 16 to define a ID tag holding cavity configured to receive an inserted ID tag 12 through the bottom opening 35. The inner surface defines an indentation 32 along the bottom opening 35 to allow for removal of an inserted ID tag. Thus, no bottom edge extending perpendicularly from the inner surface 20 (as shown in FIG. 1) is present in this embodiment to allow for the insertion of the ID tag into the bottom opening 35. Instead, a grip bar 36 is included in the inner surface 20 to provide a holding force to an inserted ID tag 18. Specifically, referring to FIG. 7A, the grip bar 36 presses the inserted ID tag 12 against the window layer 34 to removably secure the ID tag 12 in the holder via frictional forces. Again, the inserted ID tag 12 can be removed from the holder 10 by simply pulling the ID tag 12 out of the holder via the indentation 32 defined by the inner surface 20 along the bottom of the holder 10.

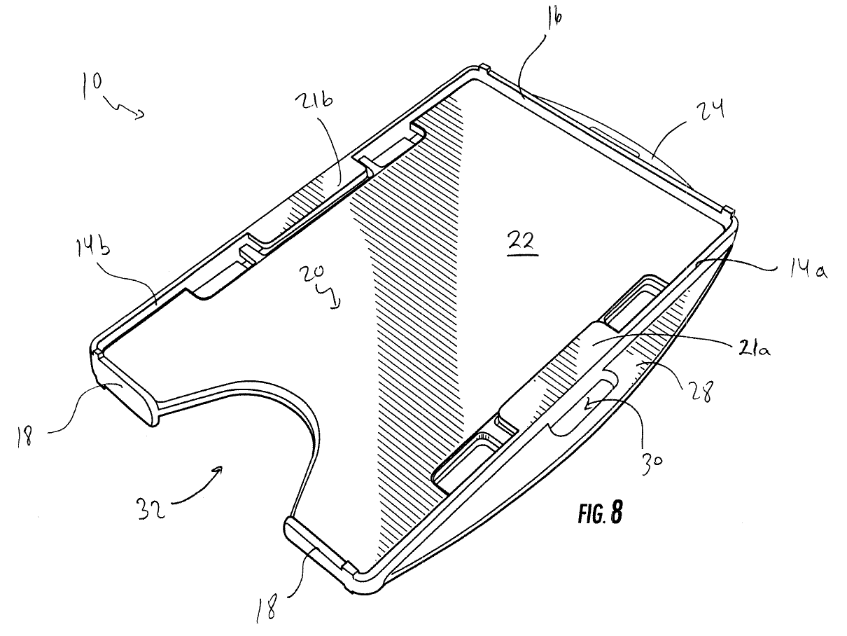

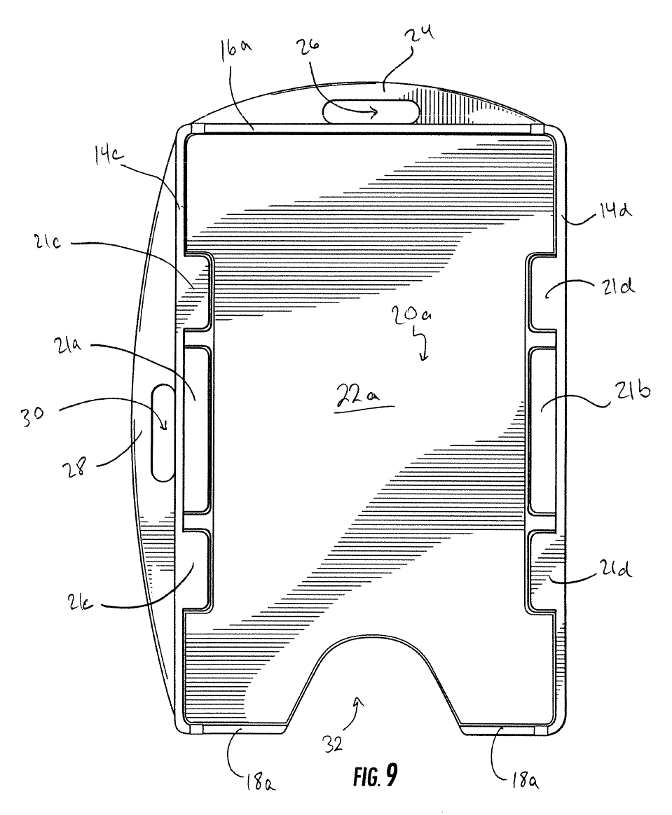

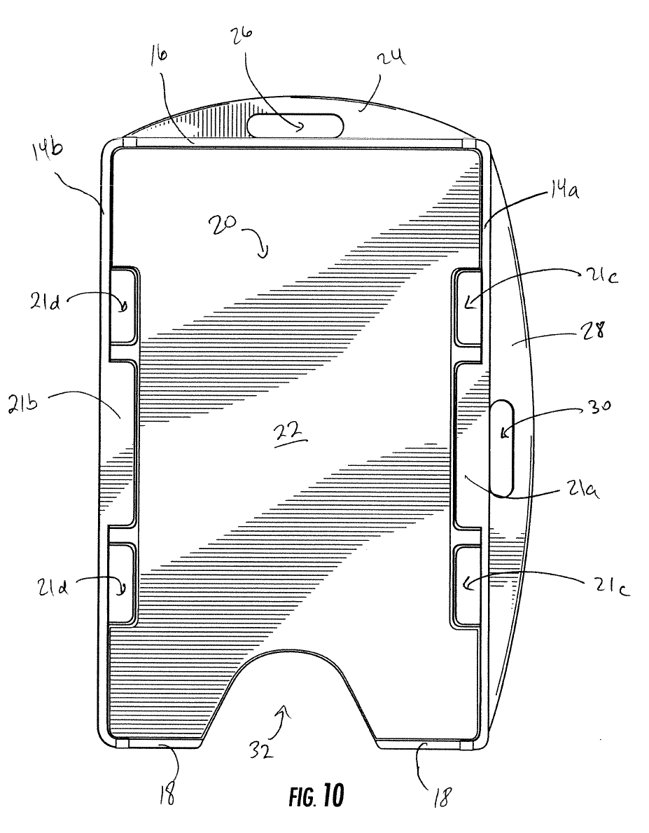

In another embodiment, the holder 10 can be configured to secure two ID tags, while still showing a face of each ID tag and protecting the electronic information stored in both ID tags. FIGS. 8-10 show a holder 10 similar to that shown and described in FIG. 1, except that the holder 10 is configured to receive and secure an ID tag on either side. Each ID tag can be secured using the side edges 14a,14b and overhang members 21a,21b similarly to that shown and described in FIG. 1. Specifically, second overhang members 21c,21d extend from the second opposing side edges 14c,14d, the second top edge 16a, and the second bottom edge 18a.

The holder 10 can be constructed from any suitable material for securing an ID tag. Preferably, the holder 10 is constructed from a semi-rigid, strong material, such as polyvinyl chloride (PVC) plastic, other thermosetting or thermoplastic materials, leather, metal, etc.

The weight of the entire holder 10, with or without the weight of any inserted ID tags, is relatively light so that the holder can easily be worn by the user. Additionally, the holder can be designed such that it is just larger than the identification tag itself. The holder 10 can have additional engravings or advertisements on its surface. For example, a company's logo or school's mascot can be displayed on the tag holder.

### B. Electromagnetic Blocker

No matter the specific design of the holder 10, an electromagnetic blocker is included in the identification tag holder 10 to electromagnetically inhibit and prevent skimming or stealing of electronic information stored in an inserted tag 12. As such, the electromagnetic blocker is effective at preventing unauthorized skimming of the electronic data from the contactless chip technologies in any identification tag inserted into the holder. Thus, the electromagnetic blocker prevents one from activating and/or reading the information stored in the card while it is inserted into the holder. Specifically, the electromagnetic blocker prevents electronic transmission to and from the ID tag while secured within the holding area of the holder 10.

In the embodiments shown in the Figures, the electromagnetic blocker is an electromagnetic blocking layer 22 attached to the inner surface of the holder 10. For example, the electromagnetic blocking layer 22 can be a paper-like layer adhesively attached to the inner surface 20 of the holder 10. When the identification card is a passive RFID card, for instance, the blocking layer can be a specialty paper sold under the name PAPER TYGER DEFENDER™ by Chase Corp., Tauton, Mass. This specific blocking layer paper is efficient blocking transmissions to and from about 860 MHz to about 980 MHz (such as EPC Gen 2) cards and 13.56 MHz smart cards. This blocking layer paper can be applied to (e.g., adhered to) the inside surface of the frame holder such that the blocking layer paper defines the inside surface of the frame holder that contacts the identification tag. Of course, other suitable electromagnetic blockers can be included in the holder 10. For instance, the electromagnetic blocker can be incorporated into the construction of the holder 10.

In the embodiment shown in FIGS. 8-10, a second electromagnetic blocker can be included in the tag holder. For example, a second electromagnetic blocking layer 22a can be applied (e.g., adhered) to the opposite side 20a of the inner surface 20.

### C. Use of Identification Tag Holder

After inserting an ID tag 12 into the holder 10, the user can display the face 13 of the inserted ID tag 12 while wearing the holder 10 allowing immediate visual reading of its face. Specifically, the head 24 of the holder 10 includes an aperture 26 for receiving cords or clips from wearing the holder, such as around one's neck or wrist, or attaching it to one's clothing. The arm 28 defining the aperture 30 can also be used to attach the holder to the wearer via a cord, clip, or other fastening material.

While inserted in the holder 10, the electromagnetic blocking layer 22 prevents any skimming or stealing of the electronic information stored in the ID tag 12. When the user desires to use or activate the electronic information stored in the ID tag 12, the ID tag 12 is simply removed from the holder 10 allowing for its electronic use. Then, the user can reinsert the ID tag 12 into the holder 10 to safely protect the electronic information in the ID tag 12.

These and other modifications and variations to the present invention may be practiced by those of ordinary skill in the art, without departing from the spirit and scope of the present invention, which is more particularly set forth in the appended claims. In addition, It should be understood the aspects of the various embodiments may be interchanged both in whole or in part. Furthermore, those of ordinary skill in the art will appreciate that the foregoing description is by way of example only, and is not intended to limit the invention so further described in the appended claims.

What is claimed:

1. An electromagnetic blocking tag holder comprising:
an identification tag holding area defined by opposing side edges, a top edge, and a bottom edge, wherein each of the opposing side edges, the top edge, and the bottom edge extends substantially perpendicular from an inner surface, and wherein the Inner surface defines an indentation along the bottom edge;
overhang members extending substantially perpendicular from each opposing side edges and over the inner surface, wherein the overhang members are configured to removably secure an identification tag inserted within the holding area while allowing a face of the inserted identification tag to remain visible; and
an electromagnetic blocker attached to the holding area, wherein the electromagnetic blocker is configured to electromagnetically inhibit and prevent skimming or stealing of electronic information stored in the inserted identification tag.

2. The electromagnetic blocking tag holder of claim 1, wherein the electromagnetic blocker comprises an electromagnetic blocking layer attached to the inner surface of the electromagnetic blocking tag holder.

3. The electromagnetic blocking tag holder of claim 1, wherein the electromagnetic blocker comprises an electromagnetic blocking paper applied to the inner surface of the electromagnetic blocking tag holder.

4. The electromagnetic blocking tag holder of claim 3, wherein the electromagnetic blocking paper is adhered to the inner surface of the electromagnetic blocking tag holder.

5. The electromagnetic blocking tag holder of claim 1 further comprising a head defining an aperture such that the electromagnetic blocking tag holder can be attached to a cord, clip, or other fastening material.

6. The electromagnetic blocking tag holder of claim 5 further comprising an arm defining an aperture such that the electromagnetic blocking tag holder can be attached to a cord, clip, or other fastening material.

7. The electromagnetic blocking tag holder of claim 1, wherein the electromagnetic blocking tag holder is constructed from a semi-rigid plastic material.

8. The electromagnetic blocking tag holder of claim 1 further comprising a second identification tag holding area defined by opposing second side edges, a second top edge, and a second bottom edge, wherein each of the opposing second side edges, the second top edge, and the second bottom edge extends substantially perpendicular from an opposite side of the inner surface, and wherein the opposite side of the inner surface defines an indentation along the second bottom edge;
second overhang members extending substantially perpendicular from each opposing second side edges and over the opposite side of the inner surface, wherein the second overhang members are configured to removably secure a second identification tag inserted within the second holding area while allowing a face of the inserted second identification tag to remain visible.

9. The electromagnetic blocking tag holder of claim 8 further comprising a second electromagnetic blocker attached to the second holding area, wherein the second electromagnetic blocker is configured to electromagnetically inhibit and prevent skimming or stealing of electronic information stored in the inserted second identification tag.

10. An electromagnetic blocking tag holder comprising:
an identification tag holding area defined by opposing side edges and a top edge, wherein each of the opposing side edges and the top edge extends substantially perpendicular to an inner surface, and wherein the inner surface defines an indentation opposite of the top edge;
a transparent window layer attached to the holder along the side edges and the top edge to cover substantially all of the holding area, wherein a bottom opening for receiving an identification tag is defined between the transparent window layer, the inner surface, and the opposing side edges;
a grip bar included in the inner surface and configured to removably secure an inserted identification tag within the holding area by pressing the inserted ID tag against the transparent window layer; and
an electromagnetic blocker attached to the holding area, wherein the electromagnetic blocker is configured to electromagnetically inhibit and prevent skimming or stealing of electronic information stored in the inserted identification tag.

11. The electromagnetic blocking tag holder of claim 10, wherein the electromagnetic blocker comprises an electromagnetic blocking layer attached to the inner surface of the electromagnetic blocking tag holder.

12. The electromagnetic blocking tag holder of claim 10, wherein the electromagnetic blocker comprises an electromagnetic blocking paper applied to the inner surface of the electromagnetic blocking tag holder.

13. The electromagnetic blocking tag holder of claim 12, wherein the electromagnetic blocking paper is adhered to the inner surface of the electromagnetic blocking tag holder.

14. The electromagnetic blocking tag holder of claim 10 further comprising a head defining an aperture such that the electromagnetic blocking tag holder can be attached to a cord, clip, or other fastening material.

15. The electromagnetic blocking tag holder of claim 14 further comprising an arm defining an aperture such that the electromagnetic blocking tag holder can be attached to a cord, clip, or other fastening material.

16. The electromagnetic blocking tag holder of claim 10, wherein the electromagnetic blocking tag holder is constructed from a semi-rigid plastic material.

17. A method of protecting electronic information stored in an identification tag that defines a face, the method comprising
inserting the identification tag into an identification tag holding area of an electromagnetic blocking tag holder configured to removably secure the identification tag within the holding area while allowing a face of the inserted identification tag to remain visible, wherein the electromagnetic blocking tag holder comprises an electromagnetic blocker attached to the holding area, wherein the electromagnetic blocker is configured to electromagnetically inhibit and prevent skimming or stealing of electronic information stored in the inserted identification tag.

18. The method of claim 17, wherein the identification tag holding area is defined by opposing side edges, a top edge, and a bottom edge, wherein each of the opposing side edges, the top edge, and the bottom edge extends substantially perpendicular from an inner surface, and wherein the inner surface defines an indentation along the bottom edge, and wherein overhang members extend substantially perpendicular from each opposing side edges and over the inner surface, wherein the overhang members are configured to secure an identification tag inserted within the holding area while allowing a face of the inserted identification tag to remain visible.

19. The method of claim 18, wherein the electromagnetic blocking tag holder is configured to receive and removably secure two identification tags, each having a face displayed while secured within the electromagnetic blocking tag holder.

20. The method of claim 17, wherein the identification tag holding area is defined by opposing side edges and a top edge, wherein each of the opposing side edges and the top edge extends substantially perpendicular to an inner surface, and wherein the inner surface defines an indentation opposite of the top edge, the electromagnetic blocking tag holder further comprising a transparent window layer attached to the holder along the side edges and the top edge and covering substantially all of the holding area, wherein a bottom opening for receiving an identification tag is defined between the transparent window layer, the inner surface, and the opposing side edges; and wherein the electromagnetic blocking tag holder comprises a grip bar included by the inner surface and configured to provide a holding force to an Inserted identification tag by pressing the inserted ID tag against the transparent window layer.
